(19) United States
(12) Patent Application Publication
(10) Pub. No.: US 2010/0005026 A1
(43) Pub. Date: Jan. 7, 2010

(54) Method of communication implemented by a dating network

(76) Inventor: Johnathan Waldman, Cypress, TX (US)

Correspondence Address: Jonathan Waldman;Suite 503, 11702B Grant Road, Cypress, TX, 77429, US

(21) Appl. No.: 12/217,590

(22) Filed: Jul. 3, 2008

(51) Int. Cl. G06Q 20/00; G06Q 99/00

(52) U.S. Cl. 705/44; 705/1

(57) ABSTRACT

A method that permits a user of a dating network to request to communicate with another user of the network via a preset message, where the user making the request pays for the request and the same user may request a refund up to a point in time prior to the other user responding to the request to communicate or a preset period has expired.

### BACKGROUND

Dating networks, whether online or not online, provide people with a means of socializing and networking with each other. Often people who meet on a dating network form a lifelong relationship.

In general, dating networks present images of and biographical information on members in the network. Typically, a dating network charges users fees to use the network. In the case of an online dating network, users often make electronic payments to use the network.

Online dating networks usually have their own rules, restrictions, and fee structure. Most of the networks share the restriction that a user of the network must pay a fee to communicate with other users of the network. Usually, this is how online dating networks generate revenue.

In contemporary dating networks, there are two basic revenue models. Either a network charges a time based subscription fee (typically a monthly fee) or a network allows a user to purchase currency for use on the network.

In the subscription fee model, users of the network may contact other users without restriction during a period of use the user paid for in advance. In a currency model, a user of the network pays a specific fee or uses a specific amount of the currency each time the user chooses to contact another user. The currency model can become expensive for users and therefore is not as popular as the subscription fee model.

Though the subscription fee model is more popular, it has its issues. For example, the subscription fee is nonrefundable in the subscription fee model.

In the currency model, the fee to contact another user is not refundable. Therefore, dating networks can take advantage of unsuspecting users by presenting enticing user profiles that lure them to pay to contact the enticing profiles, where it is highly unlikely the user from the enticing profile will reply. Often, an unsuspecting user does not receive a response from a user with an enticing profile and the user requesting to make contact does not get a refund from the network. Often, users spend a large amount of money requesting to make contact with other users and receive no replies.

The present application describes a method that allows a user of a dating network to request to communicate with another user of the dating network, where the dating network refunds the user making the request when the other user does not reply to the request or a time limit to request a refund has not expired.

### SUMMARY

This specification discloses a method that permits a user (hereinafter a requesting user) to request to communicate with another user via a preset message, where the requesting user that made the request pays for such request. Upon the request, the method permits the other user to respond to the request free of charge, at which time the users become contacts of each other. If the other user does not respond to the preset message, then the method permits the requesting user to request and receive a refund of the payment for communicating the preset message. The method permits the other user to respond to the requesting user after the network refunds the requesting user; however, the response is not free of charge for the other user after network makes the refund.

### BRIEF DESCRIPTION OF THE DRAWINGS

Below is a description of example embodiments of the method, in conjunction with appended drawings, wherein like reference numerals refer to like elements in figures, and wherein:

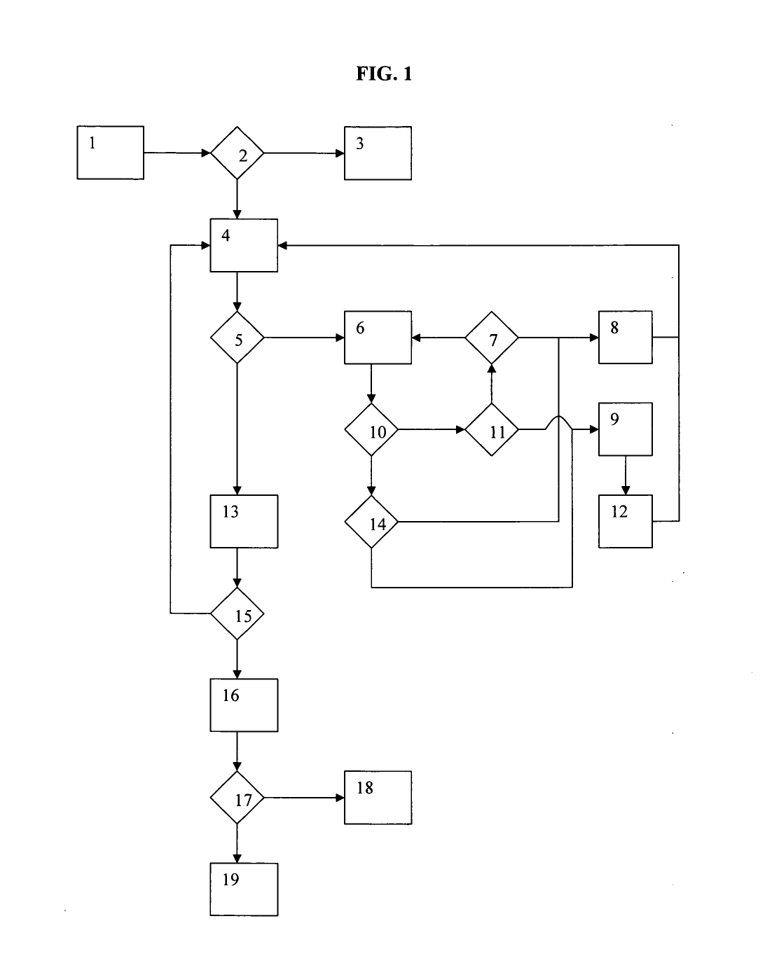

figure one (labeled “FIG. 1” in the drawings) illustrates steps to manage communicating a preset message, implemented by a preferred embodiment of the method; and

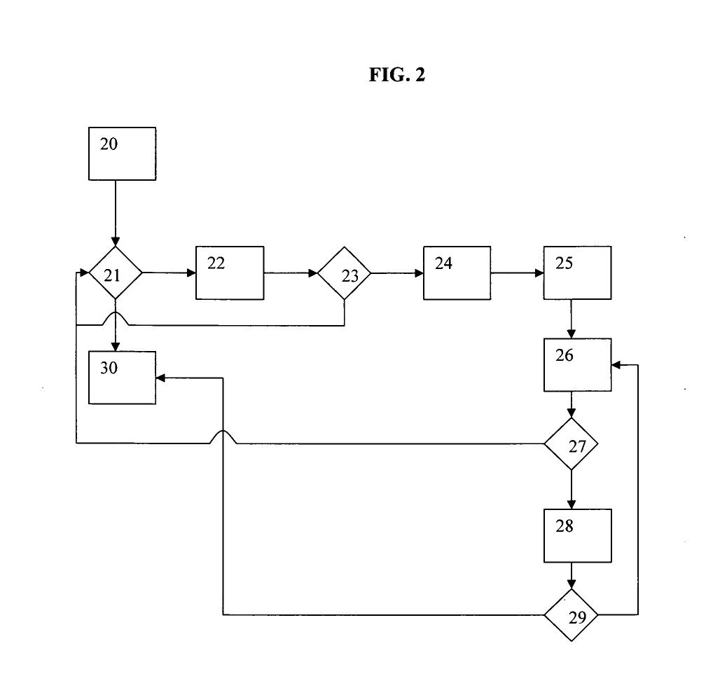

figure two (labeled “FIG. 2” in the drawings) illustrates steps implemented by a preset message queue, which is managed by preferred embodiments of the method.

### DETAILED DESCRIPTION

The present specification explains preferred embodiments of a method of communication implemented by a dating network. The present detailed description does not limit the method and the method may embody various implementations. Furthermore, figures one and two illustrate a preferred embodiment of the method and the figures are merely devices for assisting the explanation of the present detailed description and do not limit the scope of the method.

The method of communication implemented by a dating network comprises a number of steps.

In general, the method permits a requesting user to request to communicate with another user via a preset message, where the requesting user that made the request pays for such request. Upon the request, the method permits the other user to respond to the request free of charge, at which time the users become contacts of each other. If the other user does not respond to the preset message, then the method permits the requesting user to request and receive a refund of the payment for posting the preset message. The method permits the other user to respond to the requesting user after the network refunds the requesting user; however, the response is not free of charge for the other user.

In preferred embodiments of the method, a function allows the requesting user to communicate with another user of the network that is not a contact of the requesting user. A user verification function verifies whether the requesting user can freely communicate with the other user.

Typically, multiple users of the network may freely communicate with each other, if each user is a contact of the other user. However, the other user receiving a request to communicate (i.e. the target user) has to pay for a free form response when the target user responds to the requesting user after the network has refunded the requesting user.

A function provides to the requesting user at least one preset message to choose from to post to the target user, where the user verification function does not permit the requesting user to communicate freely with the target user. When users are not contacts of each other, each user may only initiate communication with the other by requesting to communicate via a preset message. However, the target user may send a free form message to the requesting user when the users are not contacts, if the target user pays for the message or the message is a reply to a request to communicate.

A function of the method verifies whether an account of the requesting user has sufficient funds to cover costs associated with posting a preset message to the target user. If the account does not have sufficient funds, a message posting function will not post the preset message to the target user. If the account does have sufficient funds, the message posting function will post the preset message to the target user.

In preferred embodiments of the method, the network has access to the account to withdraw funds when the user of the account authorizes the withdrawal of funds. A function of the method deducts funds from the account of the requesting user, where the message posting function posts the preset message to the target user. Another function refunds the account of the requesting user where the target user does not respond to the preset message and the requesting user requests a refund for the posting of the preset message.

In preferred embodiments of the method, the method further comprises a function that allows a requesting user to verify a selected preset message and the cost to post the preset message. An account deducting function deducts funds from the account to pay for posting the preset message after the requesting user verifies the preset message and the cost to post the message.

In preferred embodiments of the method, if the account of the requesting user does not have sufficient funds to pay for posting the preset message, a queue will hold the preset message until sufficient funds are added to the account of the requesting user.

In preferred embodiments of the method, a function permits adding funds to an account of a user of the dating network via a credit card payment.

In preferred embodiments of the method, at least one token represents the funds in the account. In this specification, a token is an electronic currency.

In preferred embodiments of the method, the method converts the funds into tokens and the message posting function determines whether a sufficient amount of tokens exist to post a message.

In preferred embodiments of the method, the step of refunding the account of the requesting user occurs at a time prior to the target user responding to the preset message. If the target user responds to the preset message prior to the requesting user requesting a refund for the respective posting, the requesting user may not request a refund for the posting.

As mentioned previously, the response to the preset message is free of charge when the network has not refunded the account of the requesting user. The response to the preset message is not free of charge when the network has refunded the account of the requesting user. When the response of the target user is not free of charge, a function of the network deducts funds from an account of the target user to pay for the response.

In preferred embodiments of the method, a function checks for available tokens in an account of a requesting. A similar function or the same function checks for available tokens in an account of a target user when appropriate.

In preferred embodiments of the method, the requesting user may request a refund within a set time limit, if the target user has not responded. In an implementation of the method, the time limit is thirty days.

In preferred embodiments of the method, a requesting user must wait a particular amount of time before requesting a refund. In an implementation of the method, the waiting period is three days.

In preferred embodiments of the method, the response of the target user is not preset.

In preferred embodiments of the method, the preset message comprises at least one image, where the requesting user selects the image. The selected image is an image of a greeting card, a postcard, a letter, a box of chocolates, a rose, a bouquet of flowers, a stuffed animal, any object associated with a greeting, any endearing object, or any combination thereof. Moreover, the preset message comprises text, an audio recording, a video recording, or any combination thereof.

In preferred embodiments of the method, communication between the requesting user and the target user after the target user's initial response is not preset.

In addition, in preferred embodiments of the method, the target user's initial response may be a free form message and not a preset message. The initial response may be a free form message when the requesting user does not request a refund prior to the response. If the network refunds the requesting user, the target user may pay to send a free form initial response. In a preferred embodiment of the method, the target user pays one token to send a free form initial response, where the network has refunded the requesting user.

In general, where the method makes use of a queue, the queue lists transactions between users and the network. An administrator of the queue has an option to authorize a transaction in the queue. Moreover, the administrator has the option to clear a transaction in the queue.

### DESCRIPTION OF FIGURE ONE

Figure one illustrates steps to manage posting of a preset message implemented by a preferred embodiment of the method.

Initially, through the dating network, a user of the network requests to contact another user (i.e. a target user) of the network 1. Typically, either user is a member of the network.

Next, a function determines if the target user is a contact of the requesting user 2. Typically, a contact of a user of the network is a member of the network.

If the target user is a contact of the requesting user, the requesting user may author and post a message to the target user 3.

If the target user is not a contact of the requesting user, the source user may choose to select a preset message by a function in the network 4. Typically, the preset message is an image; however, the message may be text. In addition, the message may be a combination of selected preset text and a selected preset image.

In preferred embodiments of the method, the requesting user may choose a preset message, which is in text form, and then may choose an image to add to the preset message.

In preferred embodiments of the method, a function combines the image and text by rasterization. In this case, the message becomes an image including the text.

In preferred embodiments of the method, the preset message does not include contact information of the requesting user, except for the requesting user's dating network username.

Before a function of the network posts the preset message, a function of the network determines whether the requesting user has sufficient funds to pay for posting the preset message 5. Each preset message has its own cost to post. In a preferred embodiment of the method where the method implements tokens to represent funds, a preset message may cost one or more tokens.

If the requesting user does not have sufficient funds to post a preset message, the requesting user may add funds to an account accessible by the network 6. In a preferred embodiment of the method where the method implements tokens to represent funds, a function converts deposited funds of the account to tokens.

In preferred embodiments of the method, a function determines whether a user is using a credit card to deposit funds 10, and if a user is using a credit card, a function determines whether the network is capable of validating and accepting a credit card 11. Next, a function determines whether the credit card is a valid credit card of the requesting user 7. A similar function may validate other forms of payment.

In other embodiments of the method, a function may validate a PAYPAL account or an electronic check.

Where a user does not use a credit card to pay for fees associated with posting a preset message, a function of the network determines whether another function clears payment for posting the preset message 14.

In a preferred embodiment of the method where the method implements tokens to represent funds, if a requesting user has sufficient funds to cover the cost of a token, a function converts the funds into tokens that the requesting user may spend to post preset messages to other users 8.

In a preferred embodiment of the method where the method implements tokens to represent funds, if a requesting user does not have sufficient funds to cover the cost of a token, the network provides the account of the user with a temporary token 9.

In preferred embodiments of the method, the network holds the preset message in a queue until a function converts the necessary number of temporary tokens into permanent tokens to cover the cost of posting the preset message chosen by the requesting user 12.

In preferred embodiments of the method, a function converts the temporary tokens to permanent tokens when sufficient funds are in an account of the requesting user to cover the cost of the permanent tokens.

After a function insures the requesting user has sufficient funds to cover the cost of posting a preset message, a function provides the requesting user with an option to confirm the selected preset message and the cost to post the preset message 13. Next, a function determines whether the requesting user approves posting the selected preset message 15. If the requesting user approves the posting and the payment, a function of the network deducts funds from an account of the user accessible to the network 16.

In preferred embodiments of the method where the method implements tokens, the requesting user can only see the sum of permanent tokens in his or her account. Next, a function of the network then determines whether a permanent token was used by the network to pay for the posting the preset message 17. As previously mentioned, if the network spends a temporary token to post a preset message, the network holds the message in a queue 18; otherwise, a function posts the message to the target user 19.

### DESCRIPTION OF FIGURE TWO

Figure two illustrates steps implemented by a preset message queue managed by preferred embodiments of the method.

Initially, an administrator logs onto a website hosting an online dating network 20.

Next, a function of the network allows an administrator to view whether payments are pending approval 21. Typically, the payments viewed by the administrator are credit card payments.

In preferred embodiments of the method, a function of the queue allows the administrator to authorize or clear a credit card transaction 22. The function also allows the administration to clear a payment of another form.

If a transaction is a credit card payment, a function runs the payment through a payment possessor, which checks the validity of the credit card number in the queue, and then authorizes the payment. If a transaction is another type of payment that requires clearing, the administrator manually authorizes the payment. For example, the administrator can authorize the payment if the payment is a check that has cleared.

Next, a function determines whether the administrator authorized a payment 23. If the administrator authorizes the payment, a function adds funds to an account of the respective user associated with the transaction 24. In preferred embodiments of the method where the method implements tokens, a function adds tokens to the account.

After a function adds funds to an account of the user, a function iterates through a queue of preset messages chosen by the user 25. A function of the network then applies new tokens deposited in a user account to convert temporary tokens to permanent tokens; or a function covers payments for queued preset messages until the function clears all queued preset messages, or until the function withdrawals all funds from the user's account 26.

In preferred embodiments of the method, a function determines whether the method converted all temporary tokens to permanent tokens 27.

Next, a function removes the preset message from the queue and forwards the message to the target user once a sufficient amount of temporary tokens converts to permanent tokens 28.

A function determines whether all preset messages in a queue associated with the user are cleared and posted 29.

The administrator has a choice to continue administering the queue 26 or log off the network 30.

1. A method of communication implemented by a dating network, comprising steps of:
requesting to communicate with a target user belonging to the dating network, where a user verification function verifies whether a requesting user can freely communicate with the target user;
providing to the requesting user at least one preset message to choose from to post to the target user, where the user verification function does not permit the requesting user to freely communicate with the target user;
verifying whether an account of the requesting user has sufficient funds to cover costs associated with posting a preset message to the target user, where if the account does not have sufficient funds a message posting function will not post the preset message to the target user, and where if the account does have sufficient funds the message posting function will post the preset message to the target user;
deducting funds from the account of the requesting user, where the message posting function posts the preset message to the target user; and
refunding the account of the requesting user, where there is a request for a refund.

2. The method of claim 1, further comprising a step of verifying the preset message and verifying the cost to post the preset message, where a funds deducting function deducts funds from the account of the requesting user to pay for posting the preset message after the verification of the preset message, the verification of the cost to post the preset message, and the message posting function posts the preset message.

3. The method of claim 1, wherein if the account of the requesting user does not have sufficient funds to pay for posting the preset message, a queue will hold the preset message until sufficient funds are added to the account of the requesting user.

4. The method of claim 3, further comprising a step of adding funds to an account of a user of the dating network via a credit card payment.

5. The method of claim 1, wherein at least one token represents the funds.

6. The method of claim 1, wherein the step of refunding the account of the requesting user occurs at a time prior to a response to the preset message.

7. The method of claim 6, wherein the response to the preset message is free of charge when the network has not refunded the account of the requesting user, and wherein the response to the preset message is not free of charge when the network has refunded the account of the requesting user.

8. The method of claim 7, wherein if the response is not free of charge, funds to pay for the response are deducted from an account of the target user.

9. The method of claim 7, wherein content of the response is not preset.

10. The method of claim 1, wherein the preset message comprises at least one image, wherein a function permits the requesting user to select the image.

11. The method of claim 10, wherein the image is an image of a greeting card, a postcard, a letter, a box of chocolates, a rose, a bouquet of flowers, a stuffed animal, any object associated with a greeting, any endearing object, and any combination thereof.

12. The method of claim 1, wherein the preset message comprises text, an audio recording, a video recording, or any combination thereof.

13. The method of claim 1, wherein any communication between the requesting user and the target user after the response is not preset.

14. The method of claim 3, wherein the queue comprises the steps of:
listing transactions in the queue;
permitting an administrator to authorize a transaction in the queue, where an authorized transaction leads to posting a preset message listed in the queue; and
permitting the administrator to clear a transaction in the queue.

15. The method of claim 1, wherein the dating network is electronic.

16. The method of claim 15, wherein a computer connected to a server over the Internet implements the method.

17. The method of claim 1, wherein the step of refunding the account of the requesting user must occur within a preset period.

18. A method of communication implemented by a dating network, comprising steps of:
permitting a requesting user to request to communicate with a target user via a preset message, where the requesting user that made the request pays for the request;
permitting the target user to respond to the request free of charge, at which time the users become contacts of each other;
permitting the requesting user to request and receive a refund of the payment for posting the preset message, where the target user has not responded to the preset message; and
permitting the target user to respond to the requesting user after the network refunds the requesting user, where the response is not free of charge for the target user.

19. The method of claim 18, wherein the dating network is electronic.

20. The method of claim 19, wherein a computer connected to a server over the Internet implements the method.
